(19) United States
(12) Patent Application Publication
(10) Pub. No.: US 2016/0350430 A1
(43) Pub. Date: Dec. 1, 2016

(54) APPARATUS, METHOD AND COMPUTER PROGRAM FOR MANAGING CONTENT

(71) Applicant: NAVER CORPORATION, Seongnam-si (KR)

(72) Inventor: Tae In KWON, Seongnam-si (KR)

(73) Assignee: NAVER CORPORATION, Seongnam-si (KR)

(21) Appl. No.: 15/164,055

(22) Filed: May 25, 2016

(30) Foreign Application Priority Data
May 26, 2015 (KR) 10-2015-0073089

(51) Int. Cl. G06F 17/30

(52) U.S. Cl. CPC G06F 17/30867; G06F 17/30876

(57) ABSTRACT

The method performed by an apparatus for managing content including: receiving, from a user terminal, a content and a user tag, checking an upper level tag corresponding to the received user tag by referring to a database, the databased configured to a list of one or more levels of a plurality of upper level tags and a plurality of user tags, registering the content and the received user tag, assigning the received user tag as a general tag of the content, and assigning one of the upper level tags corresponding to the received user tag as a hidden tag of the content may be provided.

### CROSS-REFERENCE TO RELATED APPLICATION

This application claims under 35 U.S.C. §119 priority to Korean Patent Application No. 10-2015-0073089, filed on May 26, 2015, in the Korean Intellectual Property Office, the disclosure of which is incorporated herein in its entirety by reference.

### BACKGROUND

1. Field

One or more example embodiments relate to methods, apparatuses, and/or computer programs for managing content.

2. Description of the Related Art

With the recent increase in supply and accessibility of communication networks (e.g., the Internet), demands for sharing content among users via the communication networks are rapidly increasing, and services for providing interfaces for sharing content between users are actively provided. Content is mainly shared based on relationships between users.

### SUMMARY

One or more example embodiments include methods, apparatuses, and/or computer programs for managing content.

Additional aspects will be set forth in part in the description which follows and, in part, will be apparent from the description, or may be learned by practice of the presented example embodiments.

According to one or more example embodiments, a method, performed by an apparatus for managing contents, of managing contents includes: receiving, from a user terminal, content and a user tag, checking an upper level tag corresponding to the received user tag by referring to a database, the database configured to store a list including one or more levels of a plurality of upper level tags and a plurality of users tag corresponding to each of the plurality of upper level tags, registering the content and the received user tag, assigning the received user tag as a general tag of the content, and assigning the upper level tag corresponding to the received user tag as a hidden tag of the content.

According to one or more example embodiments, an apparatus for managing contents includes a database configured to store a list including one or more level of a plurality of upper level tags and a plurality of use tag corresponding to each of the plurality of upper level tags, a receiver configured to receive content and a user tag from a user terminal, and a content registerer configured to check an upper level tag corresponding to the received user tag by referring to the database, register the content and the received user tag, assign the received user tag as a general tag of the content, and assign the upper level tag corresponding to the received user tag as a hidden tag of the content.

According to one or more example embodiments, a non-transitory computer-readable recording medium storing a computer program, which when executed by a computer, configures the computer to perform the aforementioned method.

According to one or more example embodiments, an apparatus for managing content, includes a database configured to store a list including one or more levels of a plurality of upper level tags and a plurality of user tags corresponding to each of the plurality of upper level tags, and at least one processor, by executing computer-readable instructions stored in a non-transitory computer-readable recording medium, configured to receive content and a user tag from a user terminal, check an upper level tag corresponding to the received user tag by referring to the database, register the content, assign the received user tag as a general tag of the content, and assign the upper level tag corresponding to the received tag as a hidden tag of the content.

### BRIEF DESCRIPTION OF THE DRAWINGS

These and/or other aspects of example embodiments will become apparent and more readily appreciated from the following description of some example embodiments, taken in conjunction with the accompanying drawings in which:

FIG. 1 is a diagram of a structure of a content sharing system according to an example embodiment;

FIG. 2 is a block diagram of an apparatus for managing contents, according to an example embodiment;

FIG. 3 is a flowchart of a method of managing contents, according to an example embodiment; and

FIGS. 4 through 7 illustrate examples of screens provided by a server and displayed on a user terminal, according to example embodiments.

### DETAILED DESCRIPTION

Various example embodiments will be described more fully hereinafter with reference to the accompanying drawings, in which some example embodiments are shown. The present disclosure may, however, be embodied in many different forms and should not be construed as limited to the example embodiments set forth herein. Rather, these example embodiments are merely provided so that this disclosure will be thorough and complete, and will fully convey the scope of example embodiments to those skilled in the art.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

As used herein, the term “and/or” includes any and all combinations of one or more of the associated listed items. Expressions such as “at least one of,” when preceding a list of elements, modify the entire list of elements and do not modify the individual elements of the list. Thus, for example, both “at least one of A, B, or C” and “A, B, and/or C” means either A, B, C or any combination thereof. It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In the present specification, it is to be understood that the terms such as “comprising,” “including” and “having” are intended to indicate the existence of the features or components, and are not intended to preclude the possibility that one or more other features or components may exist or may be added. In drawings, for convenience of description, sizes of components may be exaggerated for clarity. For example, because sizes and thicknesses of components in drawings are arbitrarily shown for convenience of description, the sizes and thicknesses are not limited thereto. In the drawings, like reference numerals refer to like elements throughout and overlapping descriptions shall not be repeated.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Example embodiments can be embodied as hardware, or a combination of hardware and software. Example embodiments can also be embodied as computer-readable codes on a computer-readable medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. Also, functional programs, codes, and code segments according to example embodiments of inventive concepts can be construed by programmers having ordinary skill in the art to which example embodiments of inventive concepts pertain.

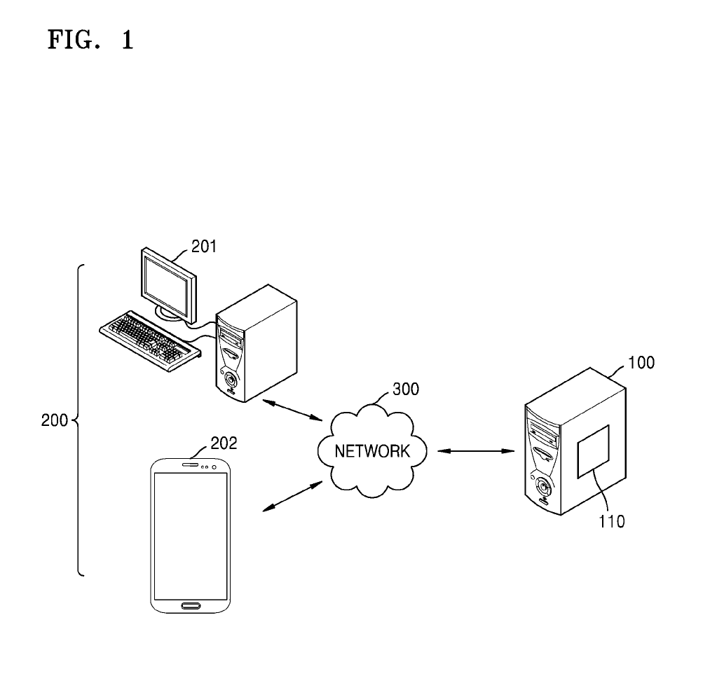

FIG. 1 is a diagram of a structure of a content sharing system according to an example embodiment.

Referring to FIG. 1, the content sharing system according to an example embodiment includes a server 100, a user terminal 200, and a network 300 connecting the server 100 and the user terminal 200.

The content sharing system according to an example embodiment may provide a content sharing service. For example, the content sharing system according to an example embodiment may register content in the server 100 when a user uploads the content, and provide an interface for other users to check the content registered in the server 100.

The term “content” denotes various types of information provided through the Internet or via computer communication, and may be in any one of various formats (e.g., images, video, and/or text). While the user uploads content, the user may assign a user tag to the content. The user tag may be based on text. For example, the text may be a word relating to the content. For example, the user may upload a photo of food and assign text, such as “food”, “food porn”, or “restaurant”, as a user tag of the photo. The user tag is a type of metadata assigned to the content, and may be used for various functions, such as to manage the content, check the content, and search for the content. Because a person who prepared or registered the content assigns the user tag, the tag that is suitable and error-free in terms of actual correlation to the content and trend reflection may be assigned.

The content sharing system according to an example embodiment may assign not only the user tag input by the user, but also an upper level tag, which is a tag of the user tag assigned to the content, thereby compensating for a limit of using a simple text-based user tag.

Referring to FIG. 1, the user terminal 200 denotes a communication terminal capable of using a web service in a wired/wireless communication environment. Here, the user terminal 200 may be a personal computer (PC) 201 of a user or a mobile terminal 202 of the user. In FIG. 1, the mobile terminal 202 is illustrated as a smart phone, but example embodiments are not limited thereto, and the mobile terminal 202 is not limited as long as an application capable of supporting web browsing is installed therein.

Meanwhile, the user terminal 200 may include a display for displaying a screen and an input device for receiving data from a user. For example, the input device may include a keyboard, a mouse, a track ball, a microphone, a button, or a touch panel, but is not limited thereto.

The network 300 may connect the user terminal 200 and the server 100 to each other. For example, the network 300 provides an access path such that the user terminal 200 accesses the server 100 and transmits and receives packet data to and from the server 100.

Although not shown in FIG. 1, the server 100 according to an example embodiment may include, for example, a memory, an input/output (I/O) unit, a program storage unit, and at least one processor. The at least one processor is a computer processing device configured to carry out the program code by performing arithmetical, logical, and input/output operations. Once the program code is loaded into the one or more processors, the one or more processors may be programmed to perform the program code, thereby transforming the one or more processors into special purpose processor(s).

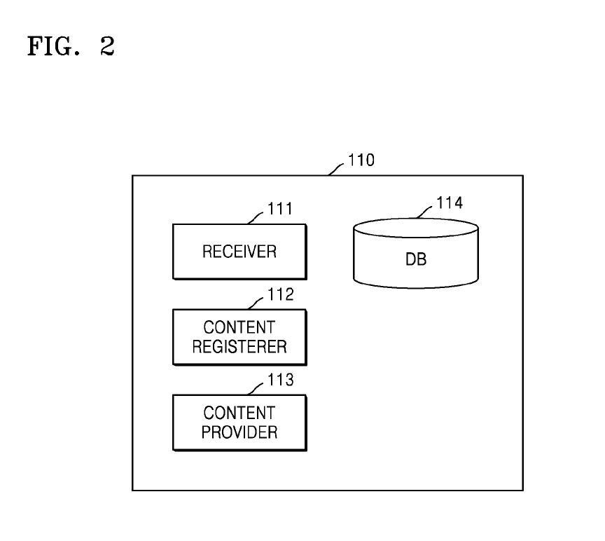

FIG. 2 is a block diagram of an apparatus 110 for managing contents, according to an example embodiment.

The apparatus 110 according to an example embodiment may include at least one processor. Accordingly, the apparatus 110 may be driven while being included in another hardware apparatus (e.g., a microprocessor or a general-purpose computer). The apparatus 110 may be mounted on the server 100 of FIG. 1. In some example embodiments, the apparatus 110 may be provided separately from the server 100 of FIG. 1 and connected to the server 100 wirelessly or in a wired manner. For example, the apparatus 110 may be connected to the server via the network 300.

In FIG. 2, components of the apparatus 110 only related to the current example embodiment are shown to prevent features of the current example embodiment from being blurred, and thus it would be obvious to one of ordinary skill in the art that the apparatus 110 may further include other general-purpose components.

Referring to FIG. 2, the apparatus 110 according to an example embodiment includes a receiver 111, a content registerer 112, a content provider 113, and a database (DB) 114. The apparatus 110 may provide a content sharing service according to an example embodiment to a plurality of users.

The receiver 111 according to an example embodiment may receive content and a user tag from, for example, the user terminal 200. The receiver 111 may receive a content and one user tag or a plurality of user tags to be assigned to the content from the user terminal 200. A type of the content may be an image, a video, or a sound source, but is not limited thereto.

The content registerer 112 according to an example embodiment may register the content and the user tag received from the user terminal 200 in the server 100. For example, the content registerer 112 may register into the server 100 the content received from the user terminal 200, and assign/register the user tag received from the user terminal 200 as a general tag of the content. For example, the content registerer 112 may register the content and the general tag in the DB 114 of the server 100.

When the number of the user tags received from the user terminal 200 is higher than a desired (or alternatively, pre-set) input number, the contents registerer 112 may assign/register the desired (or alternatively, pre-set) input number of user tags as the general tags of the content. For example, when the desired (or alternatively, pre-set) input number is 10 and the number of the user tags received from the user terminal 200 is higher than 10, the content registerer 112 may assign/register 10 tags as the general tags. The content registerer 112 may select the desired (or alternatively, pre-set) number of user tags from among the received plurality of user tags. For example, the plurality of user tags are received, and the selected user tags from among the received plurality of user tags are assigned/registered as general tags. Methods of selecting the desired (or alternatively, pre-set) number of user tags to be selected are not limited thereto. When the number of user tags is too high, a search speed or search accuracy of the apparatus 110 may be reduced, and accordingly, the number of tags to be selected may be pre-set to a certain number to prevent the search speed and/or search accuracy from decreasing.

The content registerer 112 according to an example embodiment may automatically assign a tag that is not input by the user as a hidden tag of the content. For example, the content registerer 112 may check the DB 114 for an upper level tag of the user tag(s) received from the user terminal 200, and assign/register the upper level tag as a hidden tag of the content. Because a user tag is based on simple text, searching for content by using the user tag may not be able to provide some content that a user is actually looking for. For example, when the user inputs “dog” as a search word, the user may want to search for content about several breeds of dogs. However, if content is assigned a user tag of a breed name, for example, “Maltese” or “Chihuahua”, such content may not be provided when a user searches for content using the user input (e.g., search word) “dog”. The content registerer 112 may assign an upper level tag of a tag, which is assigned by a content preparer, as a hidden tag of content. Thus, when a user searches for content using the upper level tag (e.g., a tag of an upper concept), for example, “dog,” content to which a general tag (e.g., a tag of a lower concept) such as “Maltese” or “Chihuahua” is assigned by an user can be provided as a search result.

The general tag and the hidden tag may be distinguished from each other based on whether it is displayed on the user terminal 200 while the content is displayed on the user terminal 200. The general tag is a tag assigned by the user who uploads the content, and may be displayed together with the content when the content is displayed. However, the hidden tag is a tag assigned (e.g., arbitrarily) by the content registerer 112, and may be hidden (e.g., may not be displayed) when the content is displayed. However, the general tag and the hidden tag may play substantially the same role when performing a search function using a tag. For example, when a search request using a certain tag as a search word is received, content including both the certain tag as a general tag and content including the certain tag as a hidden tag may be provided as search results.

For example, when the number of tags received from the user terminal 200 is less than a desired (or alternatively, pre-set) number, the content registerer 112 may check an upper level tag and assign the upper level tag as a hidden tag. If a hidden tag is assigned when a user has already assigned too many tags, the number of tags assigned to content is too high and thus, for example, a search speed may deteriorate. For example, the desired (or alternatively, pre-set) number may be 10, but is not limited thereto. When the desired (or alternatively, pre-set) number is 10 and when the number of tags received from the user terminal 200 is 10 or higher, the content registerer 112 may not check an upper level tag, assign the received tags as general tags, and end a content registration process. The desired number may also be referred to as a threshold number.

When a sum of the number of the user tags received from the user terminal 200 and the number of the upper level tags of the received tags is higher than a desired (or alternatively, pre-set) number, the content registerer 112 may select, from among the upper level tags, upper level tags as many as a number obtained by subtracting the number of the received user tags from the desired (or alternatively, pre-set) input number, and assign the selected upper level tags as hidden tags of the contents. For example, when the desired (or alternatively, pre-set) number is 10 as described above, and 8 user tags are received from the user terminal 200, the content registerer 112 may assign 2 upper level tags from among upper level tags corresponding to the 8 user tags as hidden tags, wherein 2 is a value obtained by subtracting 8, i.e., the number of received user tags, from 10, i.e., the desired (or alternatively, pre-set) number.

For example, when the total number of the upper level tags of the tags received from the user terminal 200 is equal to or less than a desired (or alternatively, pre-set) hidden tag input number, the content registerer 112 may assign the upper level tags as hidden tags. For example, the desired (or alternatively, pre-set) hidden tag input number may be 3. In this case, when 5 user tags are received from the user terminal 200 and the total number of upper level tags corresponding to the 5 user tags is 5, the content registerer 112 may not assign all of the upper level tags as hidden tags. If too many hidden tags are assigned, a content processing load may be increased, and if there is no basis for determining priorities between the upper level tags (e.g., selecting and determining some of the upper level tags as hidden tags), the contents processing load may be prevented from increasing by not assigning the hidden tag(s).

However, if there is a basis for determining priorities between the upper level tags, the content registerer 112 may select as many upper level tags as the desired (or alternatively, pre-set) hidden tag input number, and assign the selected upper level tags as hidden tags. For example, when there is information (e.g., popularity or trend reflection) comparable between the upper level tags, the information of the upper level tags may be compared to select the desired (or alternatively, pre-set) hidden tag input number of upper level tags, and the selected number of upper level tags may be assigned as hidden tags. As another example, when upper level tags of at least two user tags from among the user tags received from the user terminal 200 match each other, the content registerer 112 may select and assign such matching upper level tags as hidden tags.

If the server 100 is set to assign the number of hidden tags as low as possible in order to reduce abusing, and when upper level tags, which correspond to at least two user tags from among the user tags received from the user terminal 200, match each other, the content registerer 112 selects and assigns such matching upper level tags as hidden tags.

The content provider 113 according to an example embodiment may receive a content check request or a content search request, and provide a result as data or a screen.

The content provider 113 may receive the content check request from the user terminal 200. The content check request may be a screen request of a content. For example, the user terminal 200 may select a certain content from a plurality contents, and at this time, the content check request regarding the certain content may be transmitted to the content provider 113. In response to the content check request, the content provider 113 may provide a screen of the certain content. For example, the content provider 113 may provide the certain content and a general tag assigned to the certain content, and may not provide a hidden tag assigned to the certain content. When the screen provided by the content provider 113 is displayed on the user terminal 200, which transmitted the content check request, the certain content and the general tag may be displayed, and the hidden tag may not be displayed.

The content provider 113 may receive the content search request from the user terminal 200. The content search request may include a tag as a search word. For example, the user terminal 200 may transmit a content search request based on a certain tag as a search word, and upon receiving the content search request, the content provider 113 may provide, to the user terminal 200, content corresponding to the search word as a search result. For example, when a content search request using a first tag as a search word is received, the content provider 113 may provide, to the user terminal 200, a search result including content to which the first tag is assigned as a general tag or a hidden tag.

The DB 114 according to an example embodiment stores data required by the apparatus 110. For example, the DB 114 may store a table in which relationships between lower level tags (interchangeably, user tags or general tags) and upper level tags (interchangeably, hidden tags) are defined. For example, the DB 114 may store one or more levels of a plurality of upper level tags and a plurality of user tag lists corresponding to lower level tags of the upper level tags. Table 1 below is an example of a table in which lower level tags and upper level tags are defined.

TABLE 1

| Primary | Secondary | |
|---|---|---|
| Tag | Tag | Tertiary Tag |
| Food | Vegetable | Cucumber, carrot, pumpkin, . . . |
| | Fruit | Apple, orange, banana, watermelon, . . . |
| | . . . | . . . |
| Pet | Dog | Shih Tzu, Maltese, Chihuahua, . . . |
| | Cat | Russian Blue, Siamese cat, Persian cat, . . . |
| | . . . | . . . |
| . . . | . . . | . . . |

In Table 1, the primary tag is an upper level tag of the secondary tag, and the secondary tag is an upper level tag of the tertiary tag. The secondary tag is a lower level tag of the primary tag, and the tertiary tag is a lower level tag of the secondary tag. As shown in Table 1, a hierarchical relationship may be continuously set for the upper level tags and the lower level tags. However, not all tags may be assigned to have relationships with respect to the primary, secondary, and tertiary tags. For example, one primary tag may have a secondary tag as a lower level tag, but a tertiary tag that is a lower level tag of the secondary tag may not be defined. As another example, one primary tag may have lower level tags up to a quaternary tag.

Referring to Table 1, when the user inputs a tag “cucumber”, “vegetable” that is an upper level tag may be set as a hidden tag. Alternatively, when the user inputs a tag “vegetable”, “food” that is an upper level tag may be set as a hidden tag.

The DB 114 may further store contents and information about a tag assigned to the content. The DB 114 may further store various types of information (e.g., account information of a user).

For example, the receiver 111, the content registerer 112, and/or the content provider 113 may be implemented by at least one processor, which is configured to perform the aforementioned functions by executing computer-readable instructions stored in a non-transitory computer-readable recording medium.

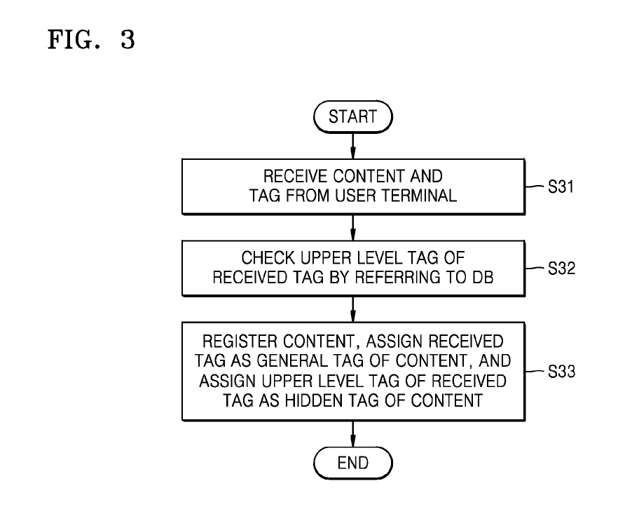

FIG. 3 is a flowchart of a method of managing contents, according to an example embodiment.

The method of FIG. 3 includes operations that are performed in sequence by the apparatus 110 of FIG. 2. Thus, details described above with reference to FIG. 2 are also applied to the method of FIG. 3 even if omitted.

Referring to FIG. 3, the receiver 111 of FIG. 2 receives content and a user tag from a user terminal 200, in operation S31. The content registerer 112 of FIG. 2 checks an upper level tag of the user tag received from the user terminal 200 by referring to the DB 114, in operation S32. The DB 114 stores one or more levels of a plurality of upper level tags and a plurality of user tags corresponding to each of the plurality of upper level tags as lower level tags or general tags. In operation S33, the content registerer 112 of FIG. 2 registers the content received in operation S31 in the server 100, assigns the tag received in operation S31 as a general tag of the content, and assigns the upper level tag checked in operation S32 as a hidden tag of the content.

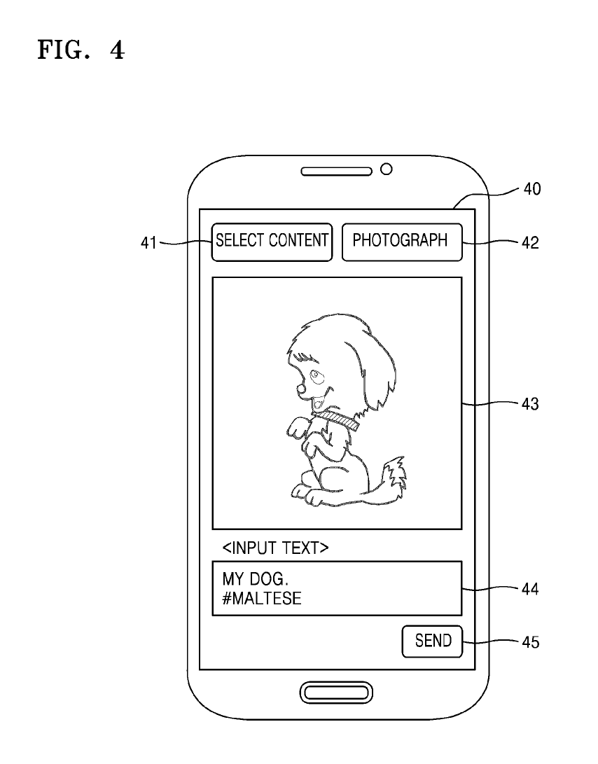

FIGS. 4 through 7 illustrate examples of screens provided by the server 100 and displayed on the user terminal 200, according to example embodiments. Functions of the apparatus 110 of FIG. 2 will now be described in detail with reference to FIGS. 4 through 7.

First, FIG. 4 illustrates an example of a screen 40 provided by the receiver 111.

For example, the screen 40 of FIG. 4 is a screen to which the user inputs content and a tag. Referring to FIG. 4, the user may select a content select button 41 or a photograph button 42 displayed on the screen 40 to select or photograph content to be uploaded. The content 43 that is selected or photographed may be displayed on the screen 40.

The user may input text to be uploaded together with the content 43 to a text input region 44. The user may input a tag to be assigned to the content 43 by using a certain identifier. In FIG. 4, the certain identifier may be a hash tag “#”. The user inputs a word together with the identifier “#” to input the word as the tag of the content 43. In FIG. 4, the user input “Maltese” as the tag. In FIG. 4, the user input one tag, but the user may input a plurality of tags. For example, when the user inputs “#Maltese #Dog”, both a tag “Maltese” and a tag “Dog” are input.

In FIG. 4, a tag is input by using an identifier, but an example embodiment is not limited thereto. A tag may be input to an input region, which is separately provided for a tag input, or may be input via any one of various methods for recognizing a tag.

The user may select a send button 45 to transmit the content 43 and the text to the receiver 111. The receiver 111 may provide the content 43 and the text to the content registerer 112. Upon receiving the content 43 and the text, the content registerer 112 may register the content 43 and the text in the DB 114 of the apparatus 110. The content registerer 112 may use the identifier included in the text to distinguish the user tag, and assign the tag as a general tag of the content 43. Information about the general tag may be stored in the DB 114. The content registerer 112 may check the DB 114 for an upper level tag of the user tag. When the upper level tag exists, the content registerer 112 may assign the upper level tag as a hidden tag of the content 43. Information about the hidden tag may be stored in the DB 114 together with the content 43.

In FIG. 4, the user input “Maltese,” as a user tag. Thus, the content registerer 112 may assign, while registering the content 43, “Maltese” as the general tag and “Dog” that is an upper level tag of “Maltese” as the hidden tag.

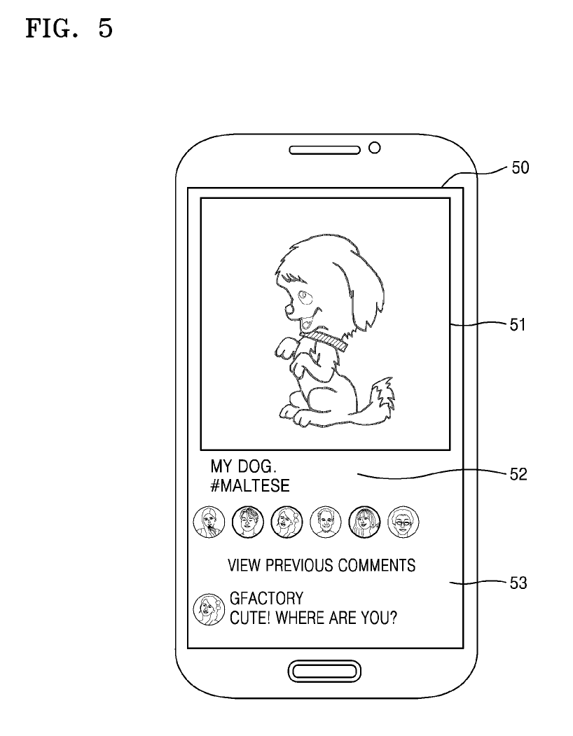

FIG. 5 illustrates an example of a screen 50 of a content provided by the content provider 113.

For example, the screen 50 of FIG. 5 may be provided by the content provider 113 when the content 43 of FIG. 4 and the tag are registered together in the server 110 by selecting the send button 45 of FIG. 4, and then a content check request is received. The screen 50 of FIG. 5 may provide content 51, text 52 corresponding to the content 51, and identification information selected by other users and comments 53 written by other users regarding the content 51.

The text 52 may display text and a general tag input by the user. Here, a hidden tag assigned by the content registerer 112 may not be displayed on the screen 50. In other words, while providing the screen 50 displaying the content 51 and the tag assigned to the content 51, the content provider 113 may display the general tag and may not display the hidden tag.

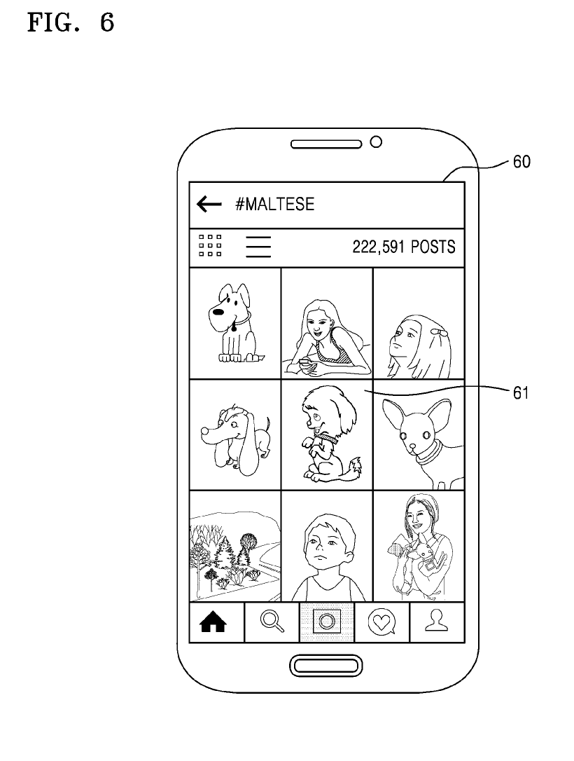

FIG. 6 illustrates an example of a tag search screen 60 provided by the content provider 113.

For example, the tag search screen 60 of FIG. 6 is an example of a screen displaying search results provided by the content provider 113 when a user searches for content by using a tag “Maltese”. The user may search for contents to which a use tag “Maltese” is assigned by inputting to a search window the text “#Maltese.” The text “#Maltese” denotes a tag identifier “#” followed by a desired tag “Maltese.” Then, the content provider 113 may list and/or provide contents including “Maltese” as a general tag and/or a hidden tag, as search results.

Content 61 that is uploaded from the screen 40 of FIG. 4 may be included in the search results of FIG. 6. Because the content 61 includes “Maltese” as a general tag, when the user searches for content by using “#Maltese” as a search word, the content 61 may be provided as a search result.

When the user selects the content 61 from the tag search screen 60 of FIG. 6, the screen 50 of FIG. 5 may be displayed.

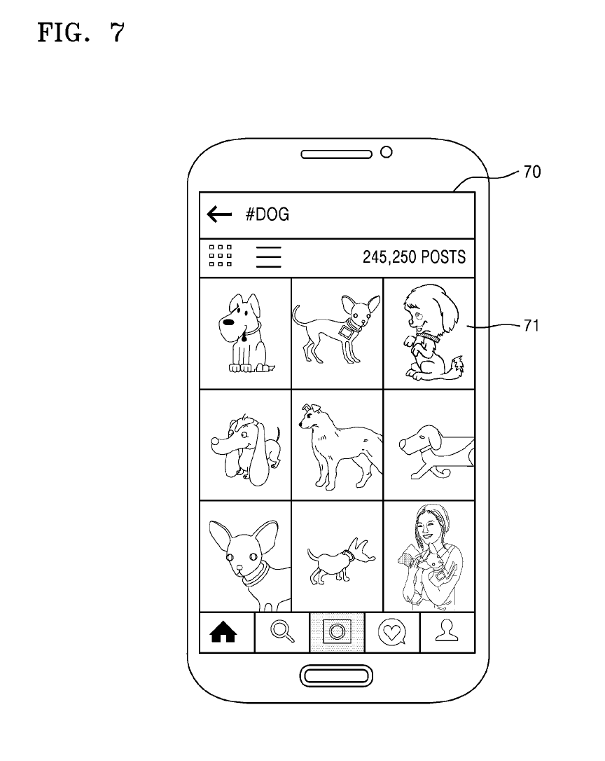

FIG. 7 illustrates an example of a tag search screen 70 provided by the content provider 113.

For example, the tag search screen 70 of FIG. 7 is an example of a screen displaying search results provided by the content provider 113 when a user searches for contents by using a tag “dog”. The user may search for content to which a tag “dog” is assigned by inputting, to a search window, text “#dog.” The text “#dog” denote a tag identifier “#” followed by a desired tag “dog.” Then, the content provider 113 may list and/or provide contents including “dog” as a general tag or a hidden tag, as search results.

The content 71 that is uploaded from the screen 40 of FIG. 4 may be included in the search results of FIG. 7. Because the content 71 includes “Maltese” as a general tag and “dog” as a hidden tag, when the user searches for content by using “#dog” as a search word, the content 71 may be provided in the search result.

When the user selects the content 71 from the tag search screen 70 of FIG. 7, the screen 50 of FIG. 5 may be displayed.

Methods, apparatuses, and/or computer programs for managing contents, according to one or more example embodiments, may provide content sharing services based on a tag, and accordingly provide content and tag registering services.

Methods, apparatuses, and computer programs for managing contents, according to one or more example embodiments, may increase searchability of contents by not only assigning an user tag, which is input/uploaded by a user, but also automatically assigning an upper level tag corresponding to the user tag.

Also, methods, apparatuses, and/or computer programs for managing contents, according to one or more example embodiments, may increase satisfaction of a user because a content search using a tag may be performed efficiently and accurately.

The embodiments may be written as computer programs and may be implemented in general-purpose digital computers that are configured to execute the computer programs stored in a non-transitory computer-readable recording medium. Examples of the non-transitory computer-readable recording medium include magnetic storage media (e.g., ROM, floppy disks, hard disks, etc.), optical recording media (e.g., CD-ROMs, or DVDs), etc.

It should be understood that example embodiments described herein should be considered in a descriptive sense only and not for purposes of limitation. Descriptions of features or aspects within each example embodiment should typically be considered as available for other similar features or aspects in other example embodiments. While one or more example embodiments have been described with reference to the figures, it will be understood by those of ordinary skill in the art that various changes in form and details may be made therein without departing from the spirit and scope of the inventive concept as defined by the following claims.

What is claimed is:

1. A method, performed by an apparatus for managing contents, of managing content, the method comprising:
receiving, from a user terminal, content and a user tag;
checking an upper level tag corresponding to the received user tag by referring to a database, the databased configured to store a list including one or more levels of a plurality of upper level tags and a plurality of user tags corresponding to each of the plurality of upper level tags;
registering the content and the received user tag,
assigning the received user tag as a general tag of the content, and
assigning one of the upper level tags corresponding the received user tag as a hidden tag of the content.

2. The method of claim 1, further comprising:
providing, after the registering, the content and the general tag when a content check request to check the content is received such that the content and the general tag are displayed on a screen of a user terminal, through which the content check request is transmitted.

3. The method of claim 1, further comprising:
after the registering, when a content search request using a first tag as a search word is received, providing, as a search result, content to which the first tag is assigned as a general tag or a hidden tag.

4. The method of claim 1, wherein
the receiving comprises receiving a plurality of user tags,
the checking comprises checking an upper level tag corresponding to each of the received plurality of user tags when a number of the received plurality of user tags is lower than a threshold number, and
the registering comprises assigning the upper level tag as a hidden tag of the content.

5. The method of claim 1, wherein
the receiving comprises receiving a plurality of user tags, and
the registering comprises, when a number of the received plurality of user tags is higher than a threshold number, assigning the threshold number of user tags, from among the plurality of user tags, as general tags of the content in an order in which the received plurality of tags are received.

6. The method of claim 1, wherein
the receiving comprises receiving a plurality of user tags, and
the registering comprises, when a sum of a number of the received plurality of user tags and a number of a plurality of upper level tags corresponding to the received plurality of user tags is higher than a threshold number,
selecting, from among the plurality of upper level tags, as many upper level tags as a number obtained by subtracting the number of the plurality of upper level tags from the threshold number, and
assigning the selected upper level tags as hidden tags of the content.

7. The method of claim 1, wherein
the receiving comprises receiving a plurality of user tags, and
the registering comprises, when a number of upper level tags corresponding to the received plurality of user tags is lower than a threshold number, assigning the upper level tags as hidden tags of the content.

8. An apparatus for managing contents, the apparatus comprising:
a database configured to store a list including one or more levels of a plurality of upper level tags and a plurality of user tags corresponding to each of the plurality of upper level tags;
a receiver configured to receive content and a user tag from a user terminal; and
a content registerer configured to
check an upper level tag corresponding to the received user tag by referring to the database,
register the content and the received user tag,
assign the received user tag as a general tag of the content, and
assign the upper level tag corresponding to the received user tag as a hidden tag of the content.

9. The apparatus of claim 8, further comprising:
a content provider configured to,
when a content check request to check the content is received, provide the content and the general tag on a screen of a user terminal, through which the content check request was transmitted, and
when a content search request using a first tag as a search word is received, provide, as a search result, at least one content to which the first tag is assigned as a general tag or a hidden tag.

10. An apparatus for managing content, the apparatus comprising:
a database configured to store a list including one or more levels of a plurality of upper level tags and a plurality of user tags corresponding to each of the plurality of upper level tags; and
at least one processor, by executing computer-readable instructions stored in a non-transitory computer-readable recording medium, configured to,
receive content and a user tag from a user terminal,
check an upper level tag corresponding to the received user tag by referring to the database,
register the content and the received user tag,
assign the received user tag as a general tag of the content, and
assign the upper level tag corresponding to the received tag as a hidden tag of the content.

11. The apparatus of claim 10, the at least one processor is further configured to, when a content check request to check the content is received from a user terminal, provide the content and the general tag on a screen of a user terminal.

12. The apparatus of claim 11, the at least one processor is further configured to, when a content search request using a first tag as a search word is received from a user terminal, provide, as a search result, at least one content to which the first tag is assigned as a general tag or a hidden tag on a screen of the user terminal.
